(19) United States
(12) Patent Application Publication
(10) Pub. No.: US 2012/0024691 A1
(43) Pub. Date: Feb. 2, 2012

(54) METHOD FOR SUPPORTING AND/OR INTENSIFYING A PHYSICAL AND/OR CHEMICAL REACTION, AND A REACTION DEVICE FOR CARRYING OUT SAID METHOD

(75) Inventor: Vadim Gogichev, Moscow (RU)

(73) Assignee: PHILIPPE SAINT GER AG, Walchwil (CH)

(21) Appl. No.: 13/264,361

(22) PCT Filed: Apr. 15, 2010
(86) PCT No.: PCT/EP2010/054987

§ 371 Date: Oct. 19, 2011

(30) Foreign Application Priority Data
Apr. 15, 2009 (CH) 00592/09

(51) Int. Cl. B01J 19/08

(52) U.S. Cl. 204/155; 422/186.01

(57) ABSTRACT

A new and effective method for supporting and/or intensifying a physical and/or chemical reaction in a reaction volume of a reactor (13), which is filled with a plurality of substances, comprises the steps of: providing a reactor (13) having a reaction volume, filling said reaction volume of said reactor (13) with a plurality of substances, which take part in a physical and/or chemical reaction, adding a predetermined portion of ferromagnetic particles into said reaction volume, placing said reactor (13) with its reaction volume between at least two inductors (1 1, 12), such that the magnetic fields (H1, H2) of said inductors (1 1, 12) interfere with each other in said reaction volume of said reactor (13), and supplying each of said inductors with an alternating current of predetermined amplitude and frequency.

The invention relates to intensification of physical and/or chemical processes that imply interphase mass-transfer (mass-exchange) to be fulfilled at the atomic-molecular level during different types of reactions such as hydrolysis, extraction, emulsifying, de-emulsifying, homogenization, comminuting (pulverization), re-modeling (formation of structure) and similar processes. The invention can be used in manufacturing, agricultural, microbiological, chemical, biochemical, food-manufacturing, building, metallurgical and other industries, where different hydrolisates made of plant raw materials and products of chemical and biochemical reactions and processing are used including those products produced by means of extraction, emulsifying, homogenization, comminuting (pulverization), formation of structure inducing change of output properties.

The promotion of physical and/or chemical reactions in a fluid or multi-phase medium by means of magnetically agitated magnetic material dispersed in the medium is well-known in the art. Document U.S. Pat. No. 4,338,169 discloses a process for stirring the fluid in a reaction chamber by dispersing ferromagnetic particles, or the like, in the fluid, and moving them by means of variable magnetic fields The variable magnetic fields are generated by switching between different electromagnetic coils of a coil arrangement surrounding the reaction chamber.

Document U.S. Pat. No. 4,936,687 discloses a mixing apparatus and method for performing mixing in thin liquid layers containing a suspension of magnetic particles. The apparatus includes at least two magnets or magnet systems, of which at least one is an electromagnet. The thin liquid layer is subjected to the combined magnetic field of the two magnets, which magnetic field alternatingly concentrates and fades out.

Document WO-A1-2007/118261 teaches an apparatus for enhancing the reaction efficiency between molecules and molecular varieties. Micro- or nanomagnetic particles are set in motion in a controlled manner in the fluid reaction medium by means of magnetic fields generated by variably feedable electromagnets arranged on both sides of a reaction fluid film. The electromagnets comprise a multitude of miniature or milli-magnetic coils on one side of the film, and one big magnetic coil on the other side of the film.

These known methods and devices are either restricted to thin fluid films, or use complex switchable configurations of electromagnets, which are activated alternatingly.

It is therefore an object of the invention to create a method and device for supporting and/or intensifying a physical and/or chemical reaction, which is of ample construction, is not restricted to thin film reaction zones, and can be applied to a plurality of different chemical and physical processes.

The method according to the invention comprises the steps of providing a reactor having a reaction volume, filling said reaction volume of said reactor with a plurality of substances, which take part in a physical and/or chemical reaction, adding a predetermined portion of ferromagnetic particles into said reaction volume, placing said reactor with its reaction volume between at least two inductors, such that the magnetic fields of said inductors interfere with each other in said reaction volume of said reactor, and supplying each of said inductors with an alternating current of predetermined amplitude and frequency.

According to a first embodiment of the inventive method, the inductors are oriented, such that their magnetic fields interfere with an angle between the respective magnetic field vectors of between 0° and 90°.

According to a second embodiment of the inventive method, the inductors are oriented, such that their magnetic fields interfere in an anti-parallel way. Especially, said substances and reaction products flow through said reactor in a predetermined direction-of-flow, and said interfering magnetic fields are either parallel to said direction-of-flow, or are perpendicular to said direction-of-flow.

According to a third embodiment of the inventive method, the inductors are oriented, such that their magnetic fields interfere in a perpendicularly crossing way. Especially, said substances and reaction products flow through said reactor in a predetermined direction-of-flow, and one of said interfering magnetic fields is parallel to said direction-of-flow.

According to a fourth embodiment of the inventive method, the inductors are connected to frequency transformers.

According to a fifth embodiment of the inventive method, the current amplitude of said alternating current and/or the orientation of said inductors is varied during said reaction process.

According to a sixth embodiment of the inventive method, said inductors are supplied with an alternating current of a frequency between 50 and 2000 Hz

According to a seventh embodiment of the inventive method, the amplitudes of magnetic induction of said inductors are in a range between 0.01 and 1.0 Tesla.

According to a eighth embodiment of the inventive method, said ferromagnetic particles have a diameter of between 0.1 and 5.0 mm, and are made of a soft-magnetic or hard-magnetic material with a susceptibility μ>>1.

According to a ninth embodiment of the inventive method, said ferromagnetic particles are covered with an anti-abrasive material or substance.

According to a tenth embodiment of the inventive method, said ferromagnetic particles are covered with a protective substance against chemically aggressive milieus.

According to a eleventh embodiment of the inventive method, said ferromagnetic particles are suitable to act as a metallic Fe-containing reaction accelerator.

According to a twelfth embodiment of the inventive method, said ferromagnetic particles are covered with a substance suitable to act as a metallic reaction accelerator.

According to a thirteenth embodiment of the inventive method, a chemical reaction accelerating substance is added into said reaction volume separately.

According to a fourteenth embodiment of the inventive method, said ferromagnetic particles are covered with a substance being neutral with respect to said reaction accelerating substance.

According to a fifteenth embodiment of the inventive method, a reactor made of nonmagnetic material is used.

The inventive reaction device comprises a reactor with a reaction volume inside, at least two inductors for generating a respective magnetic field, whereby said reactor is placed between said at least two inductors, such that the magnetic fields of said at least two inductors interfere with each other within said reaction volume of said reactor, and whereby said inductors are connected to respective power supplies to be applied with an alternating current of predetermined amplitude and frequency.

According to a first embodiment of the inventive reaction device, said inductors are connected to frequency transformers.

According to a second embodiment of the inventive reaction device, said reactor is made of non-magnetic material.

According to a third embodiment of the inventive reaction device, said reactor has an inlet for introducing substances into the reaction volume, and an exit for removing reaction products from said reaction volume.

According to a fourth embodiment of the inventive reaction device, said inductors can be oriented with respect to each other in different ways

The invention shall be explained below on the basis of different embodiments with respect to the accompanying drawings.

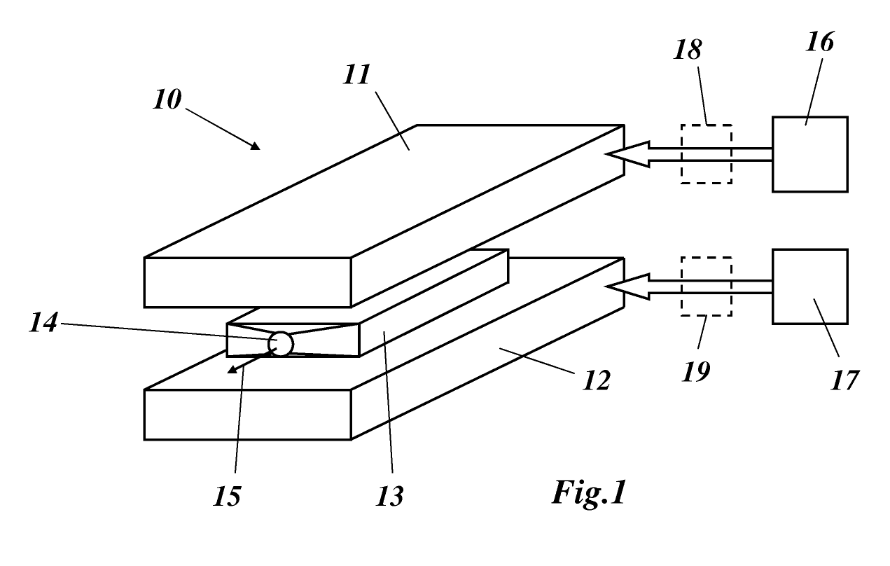

FIG. 1 shows in a perspective view a reaction device according to one embodiment of the invention;

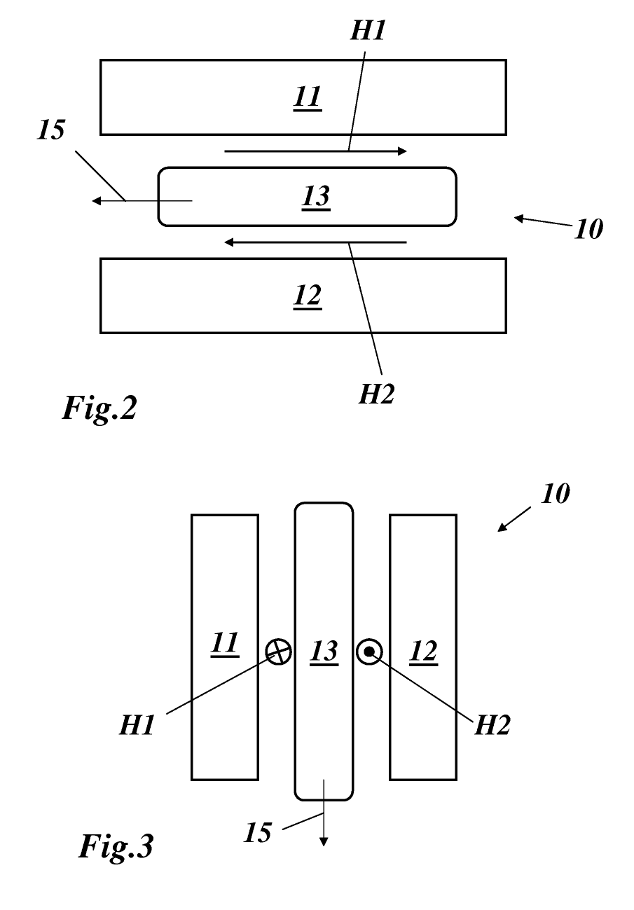

FIG. 2 shows a side view of a reaction device according to another embodiment of the invention with the magnetic fields of the inductors interfering in an anti-parallel way and being parallel to the fluid flow direction; the field vectors lie in the drawing plane;

FIG. 3 shows a side view of a reaction device according to another embodiment of the invention with the magnetic fields of the inductors interfering in an anti-parallel way and bang perpendicular to the fluid flow direction; the field vectors are perpendicular to the drawing plane;

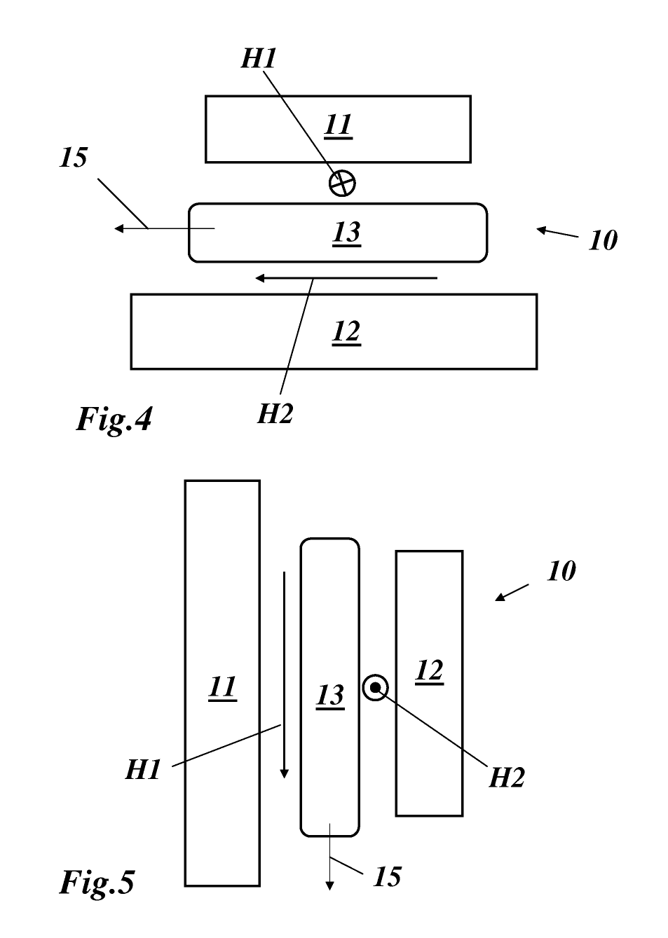

FIG. 4 shows a side view of a reaction device according to another embodiment of the invention with the magnetic fields of the inductors interfering in a perpendicularly crossing way and one of the field vectors bang parallel to the fluid flow direction;

FIG. 5 shows a side view of a reaction device according to another embodiment of the invention with the magnetic fields of the inductors interfering in an anti-parallel way and the other of the field vectors being parallel to the fluid flow direction; and

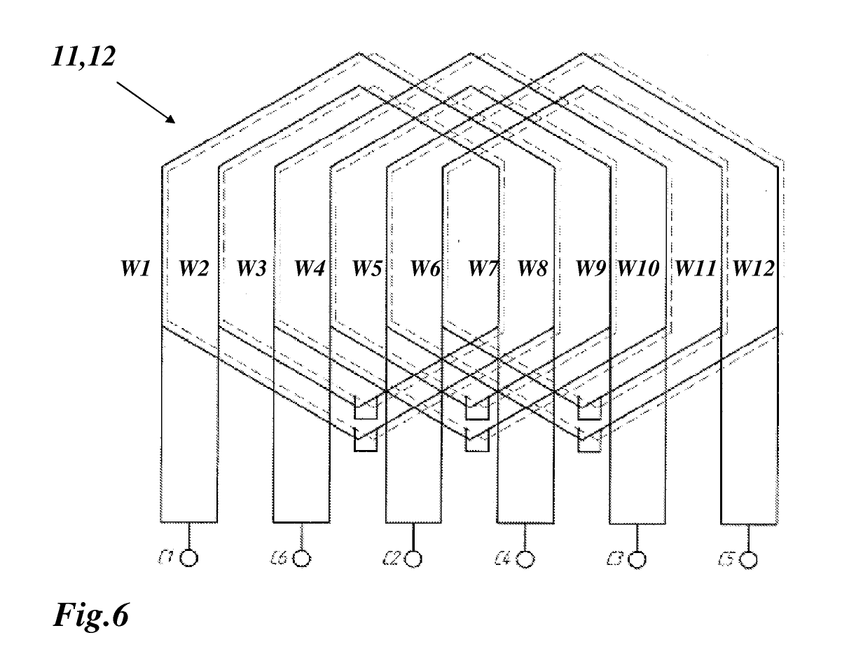

FIG. 6 shows a typical multi-phase winding configuration for the inductors used in the method according to the invention.

A novel feature of the proposed method lies in the fad that reaction processes are launched and/or implemented within permanent-magnet and/or magnetic-electrical fields to be generated inside a chamber of a reactor, which is by itself located between, as a minimum, two inductors, as shown in FIG. 1. The reaction device 10 of FIG. 1 comprises a reactor 13 with an interior reactor volume placed between two parallel inductors 11 and 12. A reactive fluid medium containing a plurality of different substances flows in a direction of flow 15 through said reactor 13, whereby the reaction products leave the reactor 13 through an exit 14. Every one of inductors 11, 12 is itself a generator of alternating magnetic fields that run along the bodies of the inductors 11, 12 with velocity v=2τf [m/s], where τ is the polar pitch of the inductor (in m), and f is the frequency of the inductor current (in Hz). The inductors 11 and 12 are connected to respective power supplies 16 and 17, and especially to frequency transformers 18 and 19 to change the frequency of the alternating supply currents. A typical winding configuration for each of the inductors 11 and 12 is shown schematically in FIG. 6. It comprises a plurality of overlapping windings W1, . . . ,W12, which are connected to a multi-phase power supply by means of terminals C1, . . . ,C6.

Certain orientations of the inductors 11, 12 (for example, see FIG. 2 to FIG. 5) and the presence of ferromagnetic particles (FP) inside the reaction volume of the reactor 13 cause an interaction or interference between the magnetic fields H1, H2 generated by said inductors 11, 12 and the ferromagnetic particles that will result in an excitation (within the milieu of the reactor 13) of secondary generations of sign-variable permanent-magnetic fields locally dispensed through the reactor volume of the reactor 13. These permanent-magnetic fields have chaotically varying values of amplitude of intensity H (induction B=μ_{FP}*H) of magnetic component. Therefore, the respective amplitude of intensity of the electric component of eddy electric field E in the form rotE=−dB/dt, where E relates to B by known correlation E=c*B (“c” is the velocity of light), will have the same chaotically varying values.

Locality of dispensation of alternating amplitudes B and E within the milieu (i.e. inside the chamber of reactor 13) is the manifestation of peculiarities of the resulting field generated by composition of the inductor's fields while ferromagnetic particles are absent inside the reactor 13: the resulting field is represented by circling and/or elliptic hodographs of component H with divHᵢ=0 (the place is represented by local line, situated within the sphere of interpolar division on central plain surface, provisionally halving the gap between the inductors and creating identically exciting opposite fields; this situation is indicative for the orientation of the inductors 11, 12 as shown in FIG. 1) to Hᵢ=Hₘₐₓ an the poles of the inductors 11, 12 (this situation is indicative for the orientation of the inductors 11, 12 as shown in FIGS. 2 and 3).

The chaotic distribution of constant amplitude of B- and E-components within the volume of milieu (chamber of the reactor 13) is a manifestation of a peculiarity that is brought into being by adding ferromagnetic particle into the reactor 13, and this peculiarity is a result of following: Every ferromagnetic particle is a “concentrator” of the B-component (where μ_{FP}>>1) and interacts with different hodographs H,, and participates in accidental collisions with other similar particles as well. This leads to an accidental, i.e. chaotic locus (pathway) of this particle's movement within the summary volume of ferromagnetic particles Therefore, the movement of all and every particles within the given volume is characterized by a common chaos state. Thus, since the ferromagnetic particles (playing a role of “concentrators” of B) together with the generated fields of the inductors participate in the process of forming the final distribution of the B- and E-amplitudes within the given milieu, the very ferromagnetic particles by their chaotic movements cause a chaotic distribution of B- and E-amplitudes within the given milieu.

The chaotic movement of the ferromagnetic particles causes inevitable realization of one of the four basic rules of electromagnetism (according to Maxwell) described by divB=0, leads to the appearance of a vector (sector) potential A of component B within the space of chaotic activity generated by the latter (the same B-component). This sector potential A also as chaotically and relates to B by relation rotA=B. Meanwhile, the sector potential A influences a wave phase in different processes and situations with wave mechanisms, and appears even if B=0. As soon as the source of appearance of the E-component in the milieu is only locally (every definite hodograph H at every point) and spatially (definite distribution of hodographs H within the milieu) alternating in time with B=μ_{FP}*H component, what unconditionally constitutes par divE=0, it is obvious that the entire milieu inside the reactor 13 containing ferromagnetic particles is under exposure of chaotic permanent-magnet generations (sui generis “permanent-magnetic storm”). General rules of permanent-magnetic generations do not differ from the rules of electromagnetism and are described by the same expressions of four basic laws assembled to Maxwell's set of equations.

Apart from the aforesaid, it must be taken in to account that every ferromagnetic particle while moving chaotically plays a role of a “micro-mixer” for a certain part of the milieu, and all ferromagnetic particles as a whole play a role of a macro-mixing device for the entire milieu evenly distributing the introduced or inputted energy through the whole mixing volume. In so doing the energy introduced in a unit of the milieu volume (energy density) is preset by the parameters of the ferromagnetic particles (μ_{FP}, form and size of a particle, quantity of particles and their weight in a unit of the reactor volume), while processing is easily maintained at the optimal level for each concrete cam. The optimal level is maintained and regulated by changing phase currents I and frequencies f in the inductors 11, 12. This peculiarity allows to include the proposed method and device in composition of automatic control system of technological processes like hydrolysis, extraction, emulsifying, homogenization, comminuting (pulverization), re-modelling (formation of structure) and other similar processes, realization of which, ceteris paribus, is limited by mass-transfer (mass-exchange) and/or by difference of restructuration of different materials reacting with one another in their mixture and existing in different states (i.e. vapor, liquid, solid), what also may be regarded as an advantage in such the devices using.

To the mentioned peculiarity of ferromagnetic particles used as a macro-mixing device another peculiarity is added: It is possible to use ferromagnetic particles as a catalyst (accelerator) with a highly-advanced catalytic surface, on which different chemical and biochemical reactions to be conducted. If during certain reactions an iron-based compound might be used as a known reaction accelerator then ferromagnetic particles would automatically play the role of such an accelerator. For any reaction, where known metallic or non-metallic reaction aerators are to be used, such aerators could be layered in advance on surface of ferromagnetic particles by any method (e.g. by plasma mating). Such methods are well-known in the art.

The distinction of using ferromagnetic particles in combination with any reaction accelerating surface is conjoint with catalytic and mass-transfer reactions on the surface of the ferromagnetic particles while particles themselves are intensively moving within the milieu and are transferring their energy to the milieu from the surfaces through the layer bordering on the developed turbulence. This layer is the baric zone of catalytic and mass-transfer reactions and hence it is obviously the reason of intensifying the processes in question. This reason is the realization of the circumstances under which every ferromagnetic particle by its own energy continuously (without intervals) generates, supports, and maintains the developed turbulence in its bordering layer, and in doing so every particle itself is intensively moving in the milieu with constant renewing of the bordering layer. The frequency of said renewing is equal to the frequency of particles co-collisions. At the end this results in the possibility of a transfer of different reactions from an area of diffusion driven reactions to kinetic ones, which is achieved by using ferromagnetic particles as energetic “organizers and carriers of place” of catalytic and mass-transfer reactions.

If any chemically aggressive milieu is used in the intensifying processes or if there is a need to protect the material (substance) of the ferromagnetic particles against such milieu, then ferromagnetic particles may be covered by a relative protective layer, but such coverage shall be inert to the aggressive milieu used.

Ferromagnetic particles can also be used as working elements for producing high-homogeneous (i.e. equal distribution of all components in any volume of mixture), powdered composites without comminuting and/or with comminuting resulting in a high-dispersion condition. Where composites contain abrasive components, the ferromagnetic particles may be covered by a layer, which precludes the attrition of the particles.

Considering the aforesaid, the invention has the following key elements:
a) exciting the aforementioned generated fields within the milieu by the respective inductors and ferromagnetic particles, and simultaneously intensively mixing of the milieu by means of interaction between those same particles and those same fields;
b) same as in point a), but the ferromagnetic particles act as an accelerator;
c) same as in points a) and b), but ferromagnetic particles are covered by layers against chemically aggressive milieu;
d) same as in points a) and b), but ferromagnetic particles are covered by layers against mechanical attrition (i.e. ferromagnetic particles are used as working elements for production of powdered materials by mixing and/or comminuting);
e) same as in points a) and b) but ferromagnetic particles are without any coverage.

As practical results have demonstrated, the intensification of the various processes may occur:
a) by way of tradition of some processes from diffusion area to kinetic one, what is evidenced by more than a thousand fold reduction of time required, for example, for extraction in comparison to the time in control process;
b) by way of accelerating certain reactions (e.g. in hydrolysis of plant raw materials, including chemical, catalytic and fermentative hydrolysis); in so doing yield of certain hydrolysis products increases at less temperatures and pressures comparing to conditions of control hydrolysis;
c) by way of intensification of mass-transfer and removal of diffusion limits in cell breathing when cultivating microorganisms (by an example of cells of Candida genus) and intensive mixing the blend consisting of liquid, microorganisms and air (time between two consecutive mitosis reduced to 5-6 minutes instead usual 4-5 hours);
d) by way of destruction of a solid phase.

The novelty of the proposed device lies in the fact that its design allows to evoke the aforementioned generated fields at two variances of the inductors' orientation as a minimum: they may be located in counter-parallel position (FIGS. 2 and 3), and/or perpendicularly one to another (FIGS. 3 and 4). The following distinction results from the variation of the positions.

In any of the positions of the inductors 11, 12 the distribution of hodographs of magnetic field intensity H with magnitudes from H=0 to H=Hₘₐₓ appears on poles of the inductors 11, 12. In the position according to FIGS. 2 and 3 (position 1) the mentioned local line with magnitude H=0 is open-circuit. The place of the break is stipulated by design of the inductors 11, 12 assembling and is at the central plane in the space between sidewall of inductors. As the consequence in these side zones so-called bordering effects appear that entail to excessive power consumption; and the more productivity the device has, the more power is consumed. In the position according to FIGS. 4 and 5 (position 2) the local line is dosed, therefore, bordering effects do not appear, and the power, otherwise being wasted in the position 1, is used for functioning of ferromagnetic particles. As the consequence, ferromagnetic particles are moving more intensively what results in an increase of form (F) and frequency (\acute{ω} of the particle's counter-collisions. This fact is evidenced by measurements of F and \acute{ω}.

The opportunity to alter the orientation of the inductors 11, 12 from position 1 to position 2 and otherwise during processing represents the new distinctive feature in the proposed device. This feature allows using the same device for regulation of the following:
a) low and high productivity in respect of end-product;
b) remodeling (restructuration) of inputs that have different strength (endurance) characteristics (from soft substances of biological nature to solid crystal materials, including quartz compounds);
c) production of high-dispersion emulsions like oil-water or homogeneous powdered mixtures producing of which requires inter alia ultrafine comminuting of inputs under increased form and frequency of ferromagnetic particles.

All this may be achieved in one installation by combining consecutive and/or parallel ‘work’ with several devices, positioned in one technological chain with alternate sequence of inductors orientations.

### HYDROLYSIS Description of Comparison Processes

There is a known method of hydrolysis to comminute inputs (such as raw wood, waste wood, straw, corn stump etc), and their further acidic, alkaline or fermentative processing at temperatures of 110-135° C. and pressures of 3-7 atm (hereinafter—absolute atmospheres) until cellulose saccharification (see for example: Kotovsky L V. Wood as forage L 1934, pages 3440). The integral drawback of the method is the requirement of high pressure which results in use of complicated devices and additional production costs.

There is a known method to resolve cellulose-containing plant materials into water-soluble sugars by a cellulose-resolved ferment (i.e. a ferment that has the ability to resolve cellulose). The process is split into two stages: 1) production of such ferment (by cultivation of cellulose-resolved microorganism under pressure of 2-4 atm), and 2) hydrolysis of the entire cultural mass of microorganism without fractioning to components (see U.S. Pat. No. 3,990,945). This method cannot result in a deep hydrolysis under higher pressure.

There is a known method of hydrolysis of plant substances containing polysaccharides under higher temperature and pressure. Before inputs proceeding into a reactor they are processed by strong add. Hydrolysis is conducted continually in one reactor in two phases. During the first stage conducted in the upper part of the reactor, inputs in vapor state are processed by strong add and water steams meanwhile pentosanes convert into furol (furan-2-carbaldehyde, artificial oil of ant), acetic add, methanol and acetone; and hexosan is resolved into di- and trisaccharides. The second stage is conducted in the bottom of the reactor whereby inputs in liquid state are processed by dilute add and water steams; meanwhile di- and trisaccharides produced at the first stage are resolved into monosaccharides, and saccharic and fatty adds are produced as well. Application of this method to inputs like birchen splinter (contains 72% of cellulose, and 15% of moisture) at 185° C. and pressure of 11 atm during 30 minutes allows to resolve 91.5% of cellulose contained in the input and to produce 16.5% of furol, 12.2% of organic adds, and 20.5% of monosaccharides in terms of cellulose content in the input.

Closest to the claimed method is the method of coarse forage hydrolysis including acidic hydrolysis of inputs under excessive pressure and higher temperature and in presence of a ferromagnetic reaction accelerator for destruction of lignin-cellulose linkages and saccharification of inputs. Inputs usually include stumps of corn crop, corn stalk, cereal (wheat, rim, oats) straw, wood and waste wood, etc. Inputs are comminuted down to particles with maximum size not more than 0.6 cm, what is achieved by putting the inputs into a grinder and further blending in a mixer, where organic particles are mixed with water Burry containing metal and acidic accelerators. As accelerators iron (Fe) or manganese (Mn), or their derivates are used in a quantity of 0.4% of dry input weight. Any non-toxic add (e.g. ortho-phosphoric, acetic hydrochloric, sulfuric, sulfurous adds, and carbon dioxide) can be used as an acidic accelerator. Under normal pressure and temperature, the acidic accelerator shall be in contact with the inputs during 2-3 hours to provide an entire enrichment of organic particles The ratio of input to add is usually taken as 40:60 (Wt %, percent by weight). After blunting (neutralization) the end-product is dried. Then the mixture proceeds to combustion (oxygenation) under higher pressure and temperature, in presence of oxygen, during 12-20 minutes. Temperature is maintained at the level of 105-110° C., pressure amounts to 10.5 kg/cm² to procure the excessive partial pressure of oxygen in an approximate value of 1.2-2.1 kg/cm². During the combustion reaction the quantity of oxygen shall be 3.75-5 Wt % of dry input weight. The oxidized mixture proceeds to a hydrolysis to be conducted until saccharification of cellulose takes place. Further the mixture goes for blunting by an acidic accelerator (different substances may be used, but ammonia is preferable) to reach the value of pH 5.5. The end product is a solution with high content of nutrients that is used for feeding without post-processing. If the product is intended to be transported or stored it needs to be dried. The significant drawback of this method is the processing of inputs under higher pressure what complicates the whole process, while the degree of hydrolysis is relatively low and the yield of saccharides is not significant.

### Examples of Hydrolysis According to the Claimed Invention.

The purpose of the invention is to reduce the excessive pressure and to increase the yield of saccharides by augmenting the degree of hydrolysis.

The purpose is achieved by the following: The hydrolysis of the plant inputs is processed within electromagnetic fields to be generated by running electromagnetic waves with frequency 50-2000 Hz, and intensity of magnetic field component Hᵢ(t)=100÷10000 Oe (induction B=0.01÷1.0 Telsa) and under excessive pressure of 1.0-2.0 atm. Meanwhile ferromagnetic particles are put into the space of the field's activity to play the role of a reaction accelerator. The fields and reaction exciting is conducted within the gap between inductors to be oriented in such a way that an angle β (between the directions of the fields) will be within the range from 0° to 90°, preferably β=0° (counter movement of waves) and/or β=90° (crossing movement of waves).

The proposed method includes the following. Inputs (cereal straw, corn stump, wood Sawdust as a case may be, or others plant raw materials) are comminuted by any known method until particles with size 0.1-1.0 mm are produced. Further the particles are mixed with water slurry containing metallic and acidic accelerators. Iron (Fe) or manganese (Mn) particles with size 0.1-1.0 mm are used as a metallic accelerator par excellence; ferromagnetic particles used for blending the mixture can also play a role of an iron accelerator by themselves.

If output is intended to be forage then orthophosphoric, hydrochloric, sulfuric and sulfurous adds may be used as an acidic accelerator. Under normal pressure and temperature the acidic accelerator shall be in contact with the input during 2-3 hours to procure the entire enrichment of organic particles. Then the mixture proceeds to the active zone of the electromagnetic fields to be generated by electromagnetic waves at the values provided above (i.e. β=0° or β=90° ; frequency of waves 50-2000 Hz, magnetic field intensity 100-10000 Oe, pressure 1.0-2.0 atm). Besides, the temperature is 100-135° C. and the processing takes 720 minutes; during this time and under such conditions the mixture incurs hydrolysis and combustion (oxygenation) simultaneously.

In the active zone of the field ferromagnetic particles being in size 1.0-5.0 mm and covered with plastic may also be loaded instead to play both roles—of magnetic fields concentrators and of additional mixing elements as well. In this case any needed metallic aerators are separately loaded into reactor.

After combustion and hydrolysis the mixture proceeds to blunting (neutralization) that is conducted by different substances but ammonia is preferable. As the result of the application of this method a solution containing 15-20% of furol, 11-14% of organic adds 18-24% of monosaccharides (as related to cellulose content in the input) is produced.

If a product is intended to be transported or stored it has to be dried. After drying it is packed in suitable packages for transportation.

FIG. 1 represents the scheme of the used reaction device 10, section; FIG. 2 to 5 represents the same by side view. The device contains a reactor 13 with ferromagnetic particles for hydrolysis and located between two inductors 11 and 12. Within the gap between the inductors 11, 12 as a consequence of the addition of two running fields the resulting electromagnetic field is generated. The field is characterized by a distribution of circular and/or elliptic hodographs of intensity H (induction B=μ_{FP}*H) and other features as described above. The inductors 11, 12 are connected to power supplies 16 and 17, and especially to frequency transformers 18 and 19 to generate electromagnetic fields of different frequency. Alteration of electromagnetic field intensity is achieved by changing the current in the inductors coils (cages) and by changing the distance between the inductors 11, 12 alike.

### LIST OF REFERENCE NUMERALS

10 reaction device
11,12 inductor
13 reactor (with reaction volume)
14 exit
15 direction-of-flow
16,17 power supply
18,19 frequency transformer
C1, . . . ,C6 terminal
H1,H2 magnetic field
W1, . . . ,W12 winding

1. A method for supporting and/or intensifying a physical and/or chemical reaction, comprising the steps of:
a. providing a reactor having a reaction volume;
b. filling said reaction volume of said reactor with a plurality of substances, which take part in a physical and/or chemical reaction;
c. adding a predetermined portion of ferromagnetic particles into said reaction volume;
d. placing said reactor between at least two inductors such that magnetic fields of said inductors interfere with each other in said reaction volume; and
e. supplying each of said inductors with an alternating current of predetermined amplitude and frequency.

2. The method of claim 1, wherein the inductors are oriented such that their magnetic fields interfere with an angle between the respective magnetic field vectors of between 0° and 90°.

3. The method of claim 2, wherein the inductors are oriented such that their magnetic fields interfere in an anti-parallel way.

4. The method of claim 3, wherein said substances and reaction products flow through said reactor in a predetermined direction-of-flow, and said interfering magnetic fields are parallel to said direction-of-flow.

5. The method of claim 3, wherein said substances and reaction products flow through said reactor in a predetermined direction-of-flow, and said interfering magnetic fields are perpendicular to said direction-of-flow.

6. The method of claim 2, wherein the inductors are oriented such that their magnetic fields interfere in a perpendicularly crossing way.

7. The method of claim 6, wherein said substances and reaction products flow through said reactor in a predetermined direction-of-flow, and one of said interfering magnetic fields is parallel to said direction-of-flow.

8. The method of claim 1, wherein the inductors are connected to frequency transformers.

9. The method of claim 1, wherein at least one of the current amplitude of said alternating current and the orientation of said inductors is varied during said reaction process.

10. The method of claim 1, wherein said inductors are supplied with an alternating current of a frequency between 50 and 2000 Hz.

11. The method of claim 1, wherein the amplitudes of magnetic induction of said inductors are in a range between 0.01 and 1.0 Tesla.

12. The method of claim 1, wherein said ferromagnetic particles have a diameter of between 0.1 and 5.0 mm, and are made of a soft-magnetic or hard-magnetic material with a susceptibility μ>>1.

13. The method of claim 12, wherein said ferromagnetic particles are covered with an anti-abrasive material or substance.

14. The method of claim 12, wherein said ferromagnetic particles are covered with a protective substance against chemically aggressive milieus.

15. The method of claim 12, wherein said ferromagnetic particles are suitable to act as a metallic Fe-containing reaction accelerator.

16. The method of claim 12, wherein said ferromagnetic particles are covered with a substance suitable to act as a metallic reaction accelerator.

17. The method of the claim 1, wherein a chemical reaction accelerating substance is added into said reaction volume separately.

18. The method of claim 17, wherein same said ferromagnetic particles are covered with a substance that is neutral with respect to said reaction accelerating substance.

19. The method of claim 1, wherein the reactor is made of non-magnetic material.

20. A reaction device for carrying out the method of claim 1, comprising:
a. a reactor with a reaction volume inside;
b. at least two inductors for generating respective magnetic fields;
wherein said reactor is placed between said at least two inductors such that the magnetic fields of said at least two inductors interfere with each other within said reaction volume, and wherein said inductors are connected to respective power supplies that provide an alternating current of predetermined amplitude and frequency.

21. The reaction device of claim 20, wherein said inductors are connected to frequency transformers.

22. The reaction device of claim 20, wherein said reactor is made of non-magnetic material.

23. The reaction device of claim 20, wherein said reactor comprises an inlet for introducing substances into the reaction volume and an exit for removing reaction products from said reaction volume.

24. The reaction device of claim 20, wherein said inductors can be oriented in different ways with respect to each other.
